(19) United States
(12) Patent Application Publication
(10) Pub. No.: US 2006/0269105 A1
(43) Pub. Date: Nov. 30, 2006

(54) Methods, Apparatus and Products for Image Capture

(76) Inventor: Ashton L. Langlinais, Lafayette, LA (US)

Correspondence Address: Jimmy Mark Gilbreth, P. O. Box 2428, Bellaire, TX, 77402-2428, US

(21) Appl. No.: 10/908,739

(22) Filed: May 24, 2005

(51) Int. Cl. G06K 9/00

(52) U.S. Cl. 382/105

(57) ABSTRACT

Apparatus and methods for obtaining an image of a license plate mounted on a moving vehicle. The methods includes determining, exposure for the image capture based on a meter reading that places greater weight on the license plate portion of the field, than on any portions of the field of view in which the license plate is not positioned. The method also includes adjusting settings for the image capture device based on the meter reading while holding device shutter speed fixed, and then capturing an image of the field of view. The image capture device is adjusted to have a fixed shutter speed appropriate for the speed of the moving vehicle, and its automatic adjustments are based on a meter reading that places greater weight on the license plate portion of the field of view.

The present invention relates to surveillance, monitoring, viewing, observing, sensing, recording, and/or identification. In another aspect, the present invention relates to methods, apparatus and products for surveillance, observing, monitoring and/or viewing of a person, place, thing, and/or a scene, and/or sensing, recording, detecting, and/or capturing an image. In even another aspect, the present invention relates to methods, apparatus, and products for obtaining an image of specific desired details about a person, place, thing or scene. In still another aspect, the present invention relates to methods, apparatus and products for surveillance, observing, monitoring and/or viewing traffic, and/or sensing, recording, detecting, and/or capturing traffic images. In yet another aspect, the present invention relates to school bus stop arm violations. In even still another aspect, the present invention relates to methods, apparatus, and products for surveillance, monitoring, observing of traffic around a school bus, and to methods and apparatus for recording and/or capturing an image of a school bus stop arm violation. In even yet another aspect, the present invention relates to methods, apparatus, and products for surveillance, monitoring, and/or observing of any object that is in rapid motion relative to the image capture system, and to methods and apparatus for recording and/or capturing an image of the object.

Many students travel to and from school in school buses. Perhaps the most dangerous time for a student during the travel to and from school is boarding or exiting a bus at the side of a street. Any frequently stopping vehicle is in danger of being struck from behind by an inattentive motorist, and a school bus is no exception . Children are generally considered not to pay sufficient attention to traffic, so it is important for the surrounding traffic to be aware of them. Upon exiting a bus, a child may pass in front of the bus and thus be out of sight of traffic approaching from behind the bus. Such a child may dart quickly around the school bus and accidently be struck by traffic passing the school bus.

Because of the safety issues and dangers inherent with school buses, in many jurisdictions, there are laws, regulations, or rules governing the operation of a motor vehicle around a school bus Most commonly motor vehicle laws prohibit the passing of a school bus that is in the process of loading/unloading passengers.

To indicate that a school bus is loading/unloading passengers, it is quite common for school buses to be equipped with a “stop arm.” This stop arm (upon which is written “stop”) is generally configured such that when the school bus is stopped and the passenger door opened to allow ingress or egress, the stop arm will extend perpendicularly from the side of the school bus indicating that passing traffic must stop. It is also quite common for a school to also be equipped with warning lights which are engaged when a school bus in the process of loading/unloading passengers. The door control mechanism is generally configured, such that operation of the door control mechanism to open the door will simultaneously engage the stop arm and/or the warning lights. Likewise, operation of the door control mechanism to close the door will retract the stop arm and turn off any warning lights.

While motorists are required to stop and wait until the stop arm is retracted and the warning lights are off, motorists often fail to notice the stop arm and flashing stop lights or simply ignore them and drive past the school bus while students are boarding or exiting. Bus drivers are in no position to record license plate numbers or descriptions of vehicles passing the bus while it is stopped to load or unload students, so motorists continue breaking the law with very little chance of being caught. Bus drivers simply cannot effectively carry out three jobs at once; i.e. drive the bus, manage the students, and record the license plate numbers of motorists who pass the bus while it is loading or unloading students.

Of course, it would be of great benefit if images of stop arm violators could be obtained. Obtaining an image of a stop arm violator allows for criminal prosecution of the violator in those instances where a law enforcement officer is not present to observe the violation and write a citation or make an arrest. Having the public be aware that images of stop arm violators could be obtained, coupled with prosecution, provides a deterrent effect for those contemplating passing a school bus with a stop arm engaged.

A number of patents disclose systems for detecting school bus stop arm violations.

U.S. Pat. No. 5,382,953, issued Jan. 17, 1995 to Hauptli, discloses a recording system that includes a sensor positioned on a school bus to detect vehicles violating an extended stop arm. A camera is positioned on the exterior of the school bus toward its rear facing forward. In this manner, the camera only takes pictures of oncoming vehicles when the sensor, which is mounted at the front end of the bus, detects the vehicle. A detection mechanism detects the extension of the stop arm on the school bus. A control unit is operable with the sensor and the detection mechanism and provides a control signal for activating the camera upon receipt of signals from the detection mechanism that the stop_arm is extended and the sensor to indicate the presence of a vehicle in the violation zone. The camera then takes still photographs of the violating vehicle while it is adjacent to the school bus.

U.S. Pat. No. 5,793,420, issued Aug. 11, 1998 to Schmidt, discloses a recording system which employs video cameras mounted on either side of a passenger vehicle, such as a school bus, for recording passing traffic as it is adjacent to the school bus. The cameras face either rearwardly or forwardly relative to the school bus to record passing vehicles and to record license plate numbers, respectively. A switching system is used that is responsive to detectors or a switching signal to determine which of the video cameras is in communication with the video recorder so as to select which view of passing traffic is recorded and displayed on a video screen in the school bus. Operator control over switching can be provided to allow the bus driver to switch between an interior camera and the external driver's side camera.

U.S. Pat. No. 5,027,200, issued Jun. 25, 1991, to Petrossian, teaches a system for providing enhanced viewing coverage about a vehicle using multiple cameras mounted to the exterior of the vehicle like the school bus video camera system of the '420 patent. To this end, the cameras are directed toward the direction in which viewing is desired. Accordingly, both systems suffer from the need to have several cameras to capture images from different fields of view with the complexity and cost disadvantages this entails. This patent also discloses use of a split CRT screen fed by corresponding cameras on either side of the vehicle as opposed to separate screens associated with each camera. In this manner, viewing of images from two different fields of view is done by looking at a single screen. Nevertheless, two cameras are still needed to produce these images.

In addition to obtaining an image of the stop arm violation, it would be of great benefit if the vehicle could be identified.

A number of optical systems exist in which an image of a passing car is captured and subjected to optical character recognition obtain the license tag. These systems which will be referred to herein as License Plate Recognition (LPR) systems, are also known as Automatic Vehicle Identification (AVI), Automatic License Plate Recognition (ALPR), Car Plate Recognition (CPR), Automatic Number Plate Recognition (ANPR), Car Plate Reader (CPR), Optical Character Recognition (OCR) for Cars, and perhaps others.

LPR systems typically utilize image capture coupled with OCR to produce a license plate number for a passing vehicle.

Early LPR systems sufferred from a low recognition rate, lower than required by practical systems. The external effects (sun and headlights, bad plates, wide number of plates types) and the limited level of the recognition software and vision hardware yielded low quality systems.

On the recognition side, improvements have been made in OCR software and hardware processing speed. Additionally, some governments have made changes to license plate fonts to assist in character recognition. Of course, changes in number color, plate background color, plate location, plate reflective properties could be made to improve image capture and OCR efficiency and accuracy.

On the image side, use of standard color or monochrome cameras to read license plates has presented the challenge of contending with a huge variety of lighting conditions, daytime, night-time, sunlight, backlight, headlights, and so on. The conventional wisdom is that one configuration simply would not cope with all conditions.

One solution is to provide a constant level and direction of illumination irrespective of any other conditions. To this end there are a number of infra red (IR) systems. These IR systems utilize IR illumination and a camera sensitive to the infrared part of the spectrum (usually fitted with a filter to restrict the visible part of the spectrum). The lens would have a manual iris set fully open and the shutter speed set to 1/1000th second. Finally an infrared source must be fitted adjacent to the camera.

Therefore, taking advantage of the retro-reflective characteristics of number plates, the illumination from the illuminator will be reflected directly back to the camera. Thus only infrared light will be seen without any visible light or other reflections or refractions.

On problem with IR systems is that at best, a monochrome image of the automobile is produced, and in many cases the automobile appears dark and is barely visible against a dark background. It is often necessary to have a conventional color image of the vehicle especially where criminal prosecution is the application. In those cases, a separate color camera is utilized in conjunction with the IR camera. However, that color camera will have to contend with the same lighting issues discussed above.

Another solution has been to couple a standard color or monochrome camera with a strobe light. However, strobes have a timing issue, and the resulting flash can be dangerously distracting to motorists.

One such system is the toll violation enforcement system by Science Applications International Corporation (“SAIC”), which company literature says the system automatically captures and identifies the license plates of vehicles traveling allegedly up to 100 mph in support of toll enforcement. Company literature further states the system processes and corrects for lighting every 1/30 of a second without the need for auto-iris or aperture changes by using a fixed iris lens and automatically selecting the optimum shutter speed. Company literature further states that “additional strobe lighting is required at night.” While the literature alleges availability of color and monochrome systems, only monochrome cameras (SAIC's EE768 and EE1000) are advertised with the system.

Finally, attempting to capture a license plate image on a vehicle passing a bus under all sorts of lighting conditions, is very different than when the vehicle is moving through a certain checkpoint or area in which the lighting conditions are somewhat controlled, and in which many times, the vehicle is moving at a slow rate of speed, i.e., gated entry systems, entrances to parking areas, and toll booths.

A number of patents and patent applications address license plate capture.

U.S. Pat. No. 4,817,166, issued on Mar. 28, 1989, to Gonzales, et al., discloses a video camera that produces an image of a license plate on a vehicle, and a scanning apparatus finds a license plate number in the image.

U.S. Pat. No. 4,878,248, issued Oct. 31, 1989, to Shyu , et al., discloses an apparatus and method for automatically recognizing the characters on a license plate which is fixed on a vehicle. A sensor/controller device is utilized to detect whether the vehicle has reached a predetermined position for image sampling, and to release a trigger signal when the vehicle has reached the predetermined position. An image processing unit is coupled to the sensor/controller device to receive the trigger signal and then to send an image-sampling instruction to an image-sampling device.

U.S. Pat. No. 5,081,685, issued on Jan. 14, 1992, to Jones, III et al., discloses a license plate reader and method for reading the characters of a license plate and for identifying the state which issued the plate utilizes image intensity transition information gathered while scanning the plate.

U.S. Pat. No. 5,651,075, issued on Jul. 22, 1997, to Frazier et al., discloses An automated license plate locator and reader which provides novel methods for correcting for perspective distortion, locating the license plate, reading the license plate, and 4) improving the confidence rating of the output signal.

U.S. Pat. No. 6,281,928, issued on Aug. 28, 2001, to Umezaki et al., discloses a positional detector device for a license plate of a motor vehicle, a camera is provided to photograph a front and rear portion of a motor vehicle so as to produce an image signal.

U.S. Pat. No. 6,373,962, issued on Apr. 16, 2002, to Kanade et al., discloses a license plate information reader device for motor vehicles, a CCD camera is provided to produce video image data involving a license plate obtained by photographing a front and rear portion of a motor vehicle.

U.S. Pat. No. 6,374,240, issued on Apr. 16, 2002, to Walker et al., discloses an apparatus for generating an image of a license plate and determining license plate characters from the image.

Then, a database is searched to determine if there is a customer record that corresponds to the license plate characters.

U.S. Patent Application Publication No. 2002/0080013, published on Jun. 27, 2002, and U.S. Pat. No. 6,433,706, issued on Aug. 13, 2002, both to Anderson, III et al., disclose a license plate number for any vehicle extant within a field of view of an electronic camera is interpreted as a character sequence group in an image.

U.S. Patent Application Publication No. 2002/0111881, published on Aug. 15, 2002, to Walker et al., discloses an apparatus for generating an image of a license plate and determining license plate characters from the image.

U.S. Patent Application Publication No. 2002/0124444, published on Sep. 12, 2002, to Davidson, discloses a license plate holder for diffusing the flashlight of a vehicle-detection camera at different angles, comprising a fixed part connected to the vehicle and a movable part that may be positioned at different angles to the vehicle, by spacing them apart with differing lengths pins or at a fixed angle, by the fixed part having an angled shape, wherein the movable part holds a license plate and a license plate cover having a micro-prismatic lens.

U.S. Patent Application Publication No. 2002/0140577, published on Oct. 3, 2002, to Kavner, discloses a method for reading a license plate disposed on a vehicle includes determining whether a license plate image is required, automatically processing the license plate image in response to determining that the license plate image is required, providing at least one verified image, and determining whether to manually read the license plate image by matching the license plate image with the at least one verified image.

U.S. Pat. No. 6,473,517, issued on Oct. 29, 2002, to Tyan et al., discloses a method for segmenting and recognizing license plates, which includes capturing an image of a license plate and preprocessing the image to prepare the image for segmentation and recognition.

U.S. Pat. No. 6,553,131, issued on Apr. 22, 2003, to Neubauer et al., discloses an intelligent camera system and method for recognizing license plates, which includes a camera adapted to independently capture a license plate image and recognize the license plate image.

U.S. Pat. No. 6,553,695, issued on Apr. 29, 2003, to Wang, discloses a vehicle video imaging system comprises a white-light LED array for illuminating retro-reflective painted parts of a vehicle's license plate, a powerful flash with a visual spectrum cutout filter and a polarizing filter for illuminating any non-retro-reflective license plate paint and the vehicle itself.

U.S. Patent Application Publication No. 2003/0089004, published on May 15, 2003, to Davidson, discloses a license plate holder for diffusing the flashlight of a vehicle-detection camera at different angles, comprising a fixed part connected to the vehicle and a movable part that may be positioned at different angles to the vehicle, by spacing them apart with differing lengths pins or at a fixed angle, by the fixed part having an angled shape, wherein the movable part holds a license plate and a license plate cover having a micro-prismatic lens.

U.S. Patent Application Publication No. 2003/0174865, published on Sep. 18, 2003, to Vernon, discloses an infrared illuminator and camera system for imaging of auto vehicle license plates.

U.S. Patent Application Publication No. 2003/0179911, published on Sep. 25, 2003, to Ho et al., discloses the detection of faces in digital images. Rather than subjecting the entire image (1) to computationally intensive face detection analysis, the image is instead segmented into regions (2) each of which has a substantially homogeneous colour. Only those regions (2) having a predominantly skin colour are then subjected to the face detection analysis. Preferably the face detection analysis is independent of facial colour.

U.S. Pat. No. 6,650,765, issued on Nov. 18, 2003, to Alves, discloses a vehicle video imaging system comprises a white-light LED array for illuminating retro-reflective painted parts of a vehicle's license plate, a powerful flash with a visual spectrum cutout filter and a polarizing filter for illuminating any non-retro-reflective license plate paint and the vehicle itself.

U.S. Patent Application Publication No. 2004/0101166, published on May 27, 2004, to Williams et al., discloses a speed measurement system for measuring speeds of vehicles, capturing images of vehicles, and detecting violation of stop sign and traffic signal laws.

U.S. Patent Application Publication No. 2004/0104813, published on Jun. 3, 2004, to Rau et al., discloses a law enforcement vehicle having a camera configured to identify a license plate.

U.S. Pat. No. 6,754,369, issued on Jun. 22, 2004, to Sazawa, discloses a running vehicle photographed at a predetermined frame period by an image pickup unit (TV camera) provided at a position above a road.

In spite of the numerous patents and publications in both the school bus stop arm violation art and the license plate capture art, there exists a need in the art for improved apparatus, methods and products relating to school bus stop violation and license plate capture.

This and other needs in the art will become apparent to one of skill in the art upon review of this specification and its drawing and claims.

### SUMMARY OF THE INVENTION

It is an object of the present invention to provide improved apparatus, methods, and products relating to school bus stop violation and license plate capture.

This and other objects of the present invention will become apparent to one of skill in the art upon review of this specification and its drawing and claims.

According to one embodiment of the present invention, there is provided a method of obtaining an image with an image capture device of a license plate mounted on a vehicle, wherein the image capture device has a field of view. The method includes determining, while the license plate is in a license plate portion of the field of view, an exposure for the device based on a meter reading that places greater weight the license plate portion of the field, than on any portions of the field of view in the license plate is not positioned, wherein the license plate portion is only a portion of the field of view. The method also includes adjusting settings for the image capture device based on the meter reading while holding device shutter speed fixed. The method even also includes capturing an image of the field of view.

According to another embodiment of the present invention, there is provided an image capture system comprising a vehicle; and an image capture device mounted on the vehicle, operating at a fixed shutter speed, wherein the image capture device comprises a field of view comprising a license plate portion of the field of view that is only a portion of the field of view, wherein the image capture device generates a meter reading that places greater weight on the license plate portion of the field, than on any portions of the field of view, and wherein the image capture device operates to capture an image based on that meter reading. According to further embodiments of this invention, the vehicle is a school bus, and the bus comprises a stop arm, and the image capture device is positioned to include the stop arm in the field of view.

According to even another embodiment of the present invention, there is provided a method of obtaining an image with an image capture device of a license plate mounted on a moving vehicle, wherein the image capture device is mounted on a second vehicle and has a field of view. The method includes determining, while license plate is in a license plate portion of the field of view, an exposure for the device based on a meter reading that places greater weight the license plate portion of the field, than on any portions of the field of view in which the license plate is not positioned, wherein the license plate portion is only a portion of the field of view. The method further includes adjusting settings for the image capture device based on the meter reading while holding device shutter speed fixed. The method even further includes capturing an image of the field of view.

According to still another embodiment of the present invention, there is provided, a method of obtaining an image with an image capture device of a license plate mounted on a moving vehicle passing a school bus with a stop arm, wherein the image capture device has a field of view, wherein the image capture device is mounted on the school bus. The method includes determining, while license plate is in a license plate portion of the field of view, an exposure for the device based on a meter reading that places greater weight the license plate portion of the field, than on any portions of the field of view in which the license plate is not positioned, wherein the license plate portion is only a portion of the field of view. The method further includes adjusting settings for the image capture device based on the meter reading while holding device shutter speed fixed. The method even further includes capturing an image of the field of view which includes the vehicle and the stop arm.

According to yet another embodiment of the present invention, the are provided products comprising computer readable media comprising instructions, or a data signal embodied in a carrier wave comprising instructions, said instructions which when carried out on a computer will implement one or more steps of the method of the present invention.

According to even still another embodiment of the present invention, there are provided methods, apparatus and products for any application where it is necessary or useful to obtain an identifiable image of a passing object (whether animate or inanimate).

These and other embodiments of the present invention will become apparent to one of skill in the art upon review of this specification and its drawing and claims.

### BRIEF DESCRIPTION OF THE DRAWINGS

In the drawings, like numbers throughout and between the drawings, refer to like items.

FIG. 1 is an illustration showing school bus 15 having stop arms 16 shown in an engaged position, upon which is mounted rapid motion image capture apparatus 100 comprising image capture device 110, with lens 102 having a viewing zone 23, with vehicle 21 traveling through viewing zone 23.

FIG. 2 is an illustration showing school bus 15 having stop arms 16 shown in an engaged position, upon which is mounted a multi-camera embodiment of rapid motion image capture apparatus 100 comprising front and rear pointed image capture devices 110, with lens 102 having a viewing zone 23, with vehicle 21 traveling through viewing zone 23.

FIG. 3 is a schematic representation of image capture system 200 comprising image capture device 110, which can further include image storage device 115, image processor 120 and switch 19.

FIG. 4 is a illustration of the 5 separate windows for the metering system for the EQ500 video camera, showing windows W0, W1, W2, W3, W4 and W5.

FIGS. 5-17 which are EQ500 screen displays of the actual operating settings.

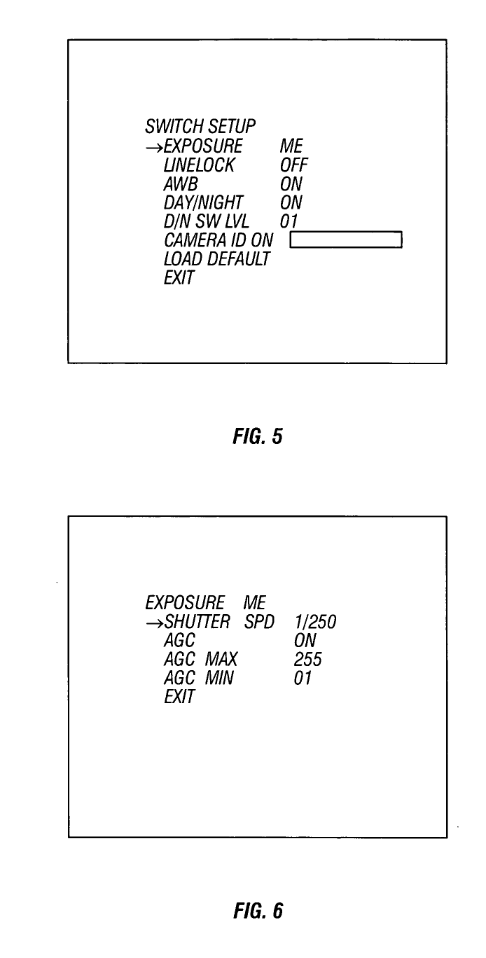

Specifically, FIG. 5 is an illustration of the SWITCH SETUP screen.

Specifically, FIG. 6 is an illustration of the EXPOSURE ME screen.

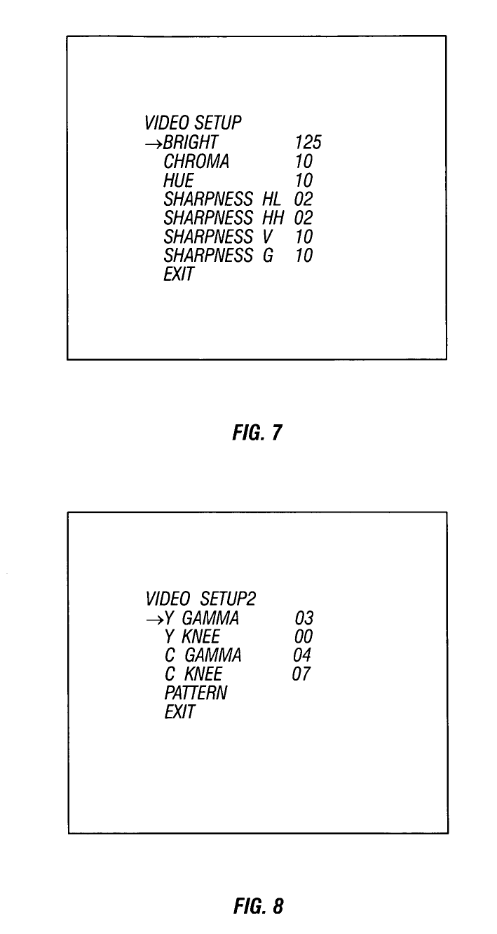

Specifically, FIG. 7 is an illustration of the VIDEO SETUP screen.

Specifically, FIG. 8 is an illustration of the VIDEO SETUP2 screen.

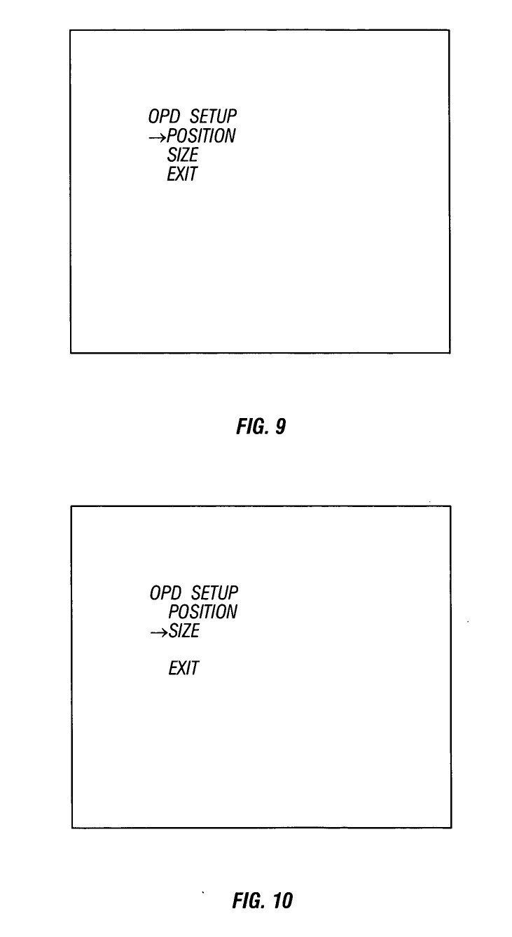

Specifically, FIGS. 9 and 10 are illustrations of the OPD SETUP screen.

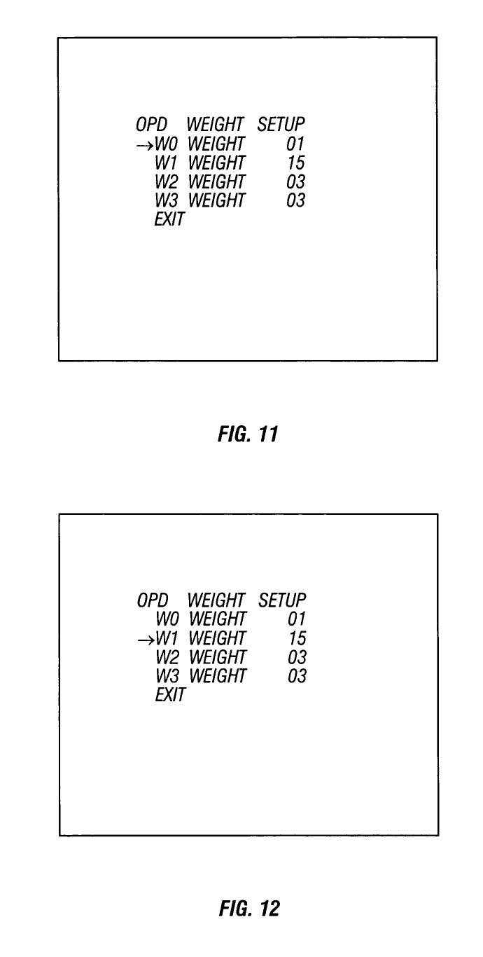

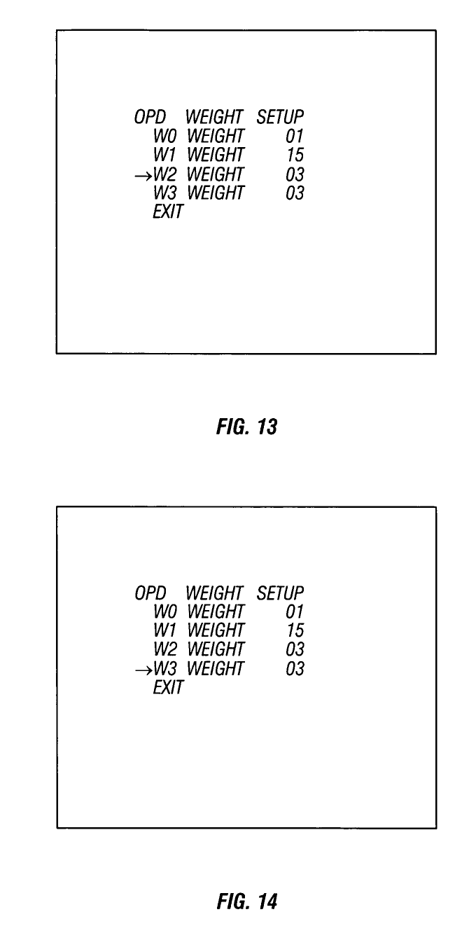

Specifically, FIGS. 11-14 are illustrations of the OPD WEIGHT SETUP screen.

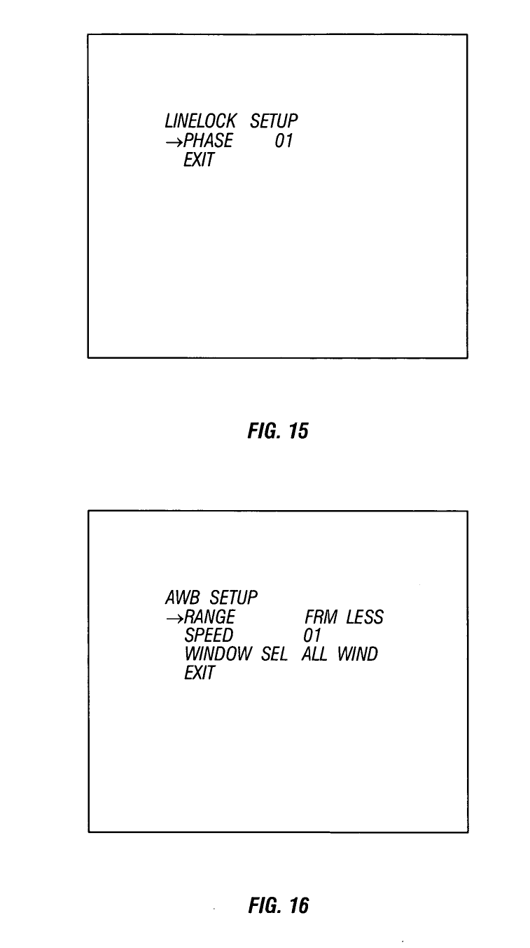

Specifically, FIG. 15 is an illustration of the LINELOCK SETUP screen.

Specifically, FIG. 16 is an illustration of the AWB SETUP screen.

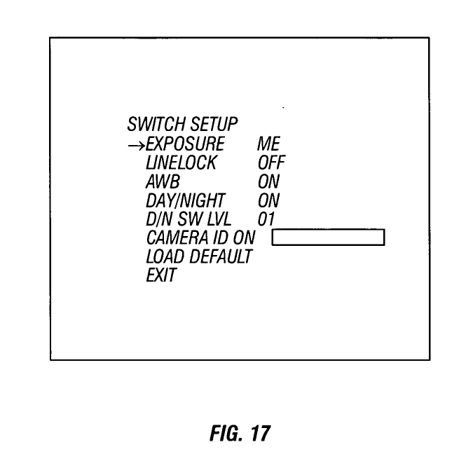

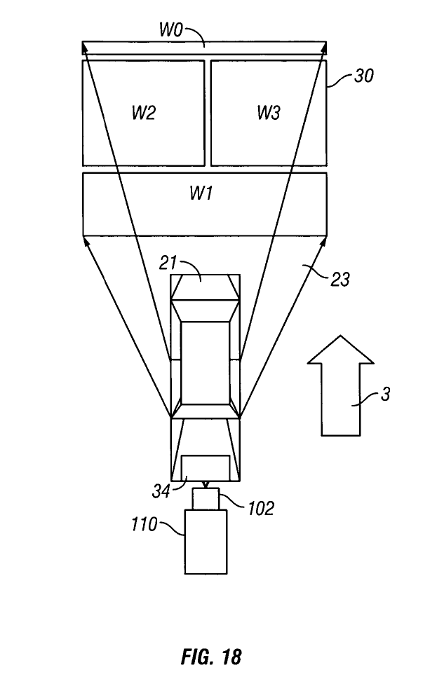

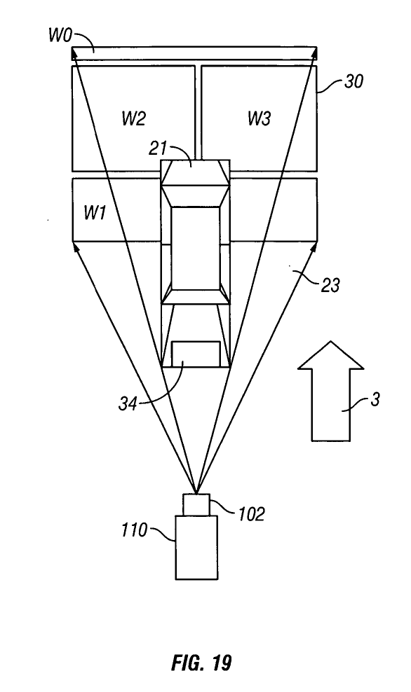

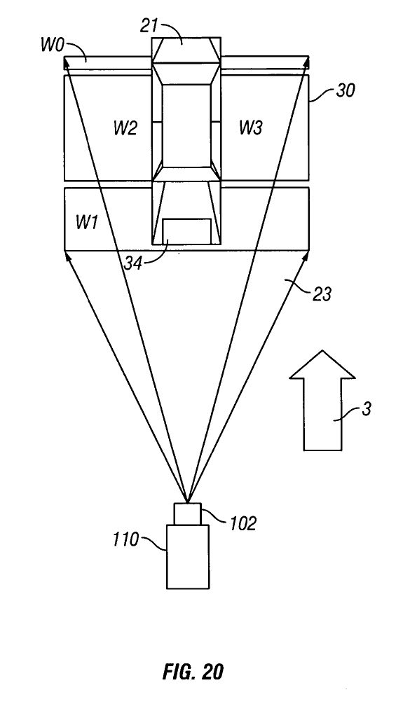

Specifically, FIG. 17 is a return to the SWITCH SETUP screen, showing a complete cycle through the setup screens.

FIGS. 18-20 is a schematic showing vehicle 21 in various positions of travel through view zone 23, with OPD windows superimposed thereon.

### DETAILED DESCRIPTION OF THE INVENTION

The present invention is most easily described by making reference to the drawings.

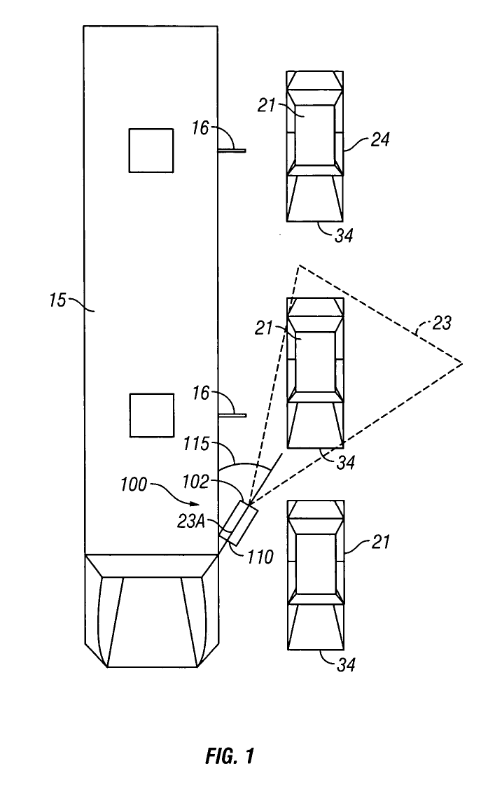

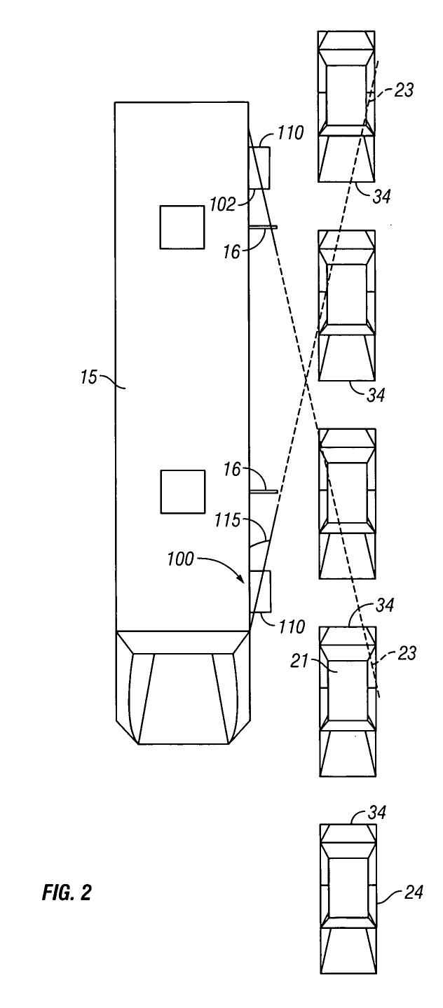

Referring first to FIGS. 1 and 2, there is shown school bus 15 having stop arms 16 shown in an engaged position, upon which is mounted rapid motion image capture apparatus 100 comprising image capture device 110, with lens 102 having a viewing zone 23, with vehicle 21 traveling through viewing zone 23. Viewing zone 23 is generally that zone which will be imaged through lens 102.

FIG. 2 illustrates the multi-camera embodiment of rapid motion image capture apparatus 100 comprising one forward facing and one backward facing image capture device 110. The present invention generally comprises at least one image capture device 110, preferable at least two image capture devices 110. It should be understood that any number of image capture devices may be utilized as desired, situated in any geometric arrangement as desired.

Mounting angle 115 is the angle between the side of bus 15 and centerline 23A of viewing zone 23, with FIG. 1 showing a larger mounting angle than FIG. 2. While any suitable mounting angle may be utilized which will allow for image capture of passing vehicle 23, it is preferred to utilize a mounting angle 115 which will include stop arm 16 in the viewing zone 23, and which will encompass an adequate portion of the travel path of vehicle 21 to capture sufficient images for identification of vehicle 21.

Image capture device 110 is utilized for capturing an image of passing vehicle 21, preferably for capturing an image of identifying features of a passing vehicle such as color, make/model, markings, and more preferably for capturing an image of vehicle license plate 34, and optionally for capturing details of the driver and any passengers. Additionally, when image capture system is equipped to record audio, it will also be used to capture sound of the incident, including any comments made by the participants. In operation, the bus driver may also provide real time description of the incident, including reading the license plate number as another confirmation of the number.

In some literature, the term “capture” is a term used in digital imaging meaning “to photograph” or “to film.” Generally, the term “capture” is used to differentiate the method by which the image is made, as “photograph” and “film” are closely associated analog film imaging, “capturing” is applied to specify a digital sensor is used. However, in the present invention, image capture is used to refer to the obtaining of the image of the passing vehicle, regardless of how it is obtained. Thus non-limiting examples of suitable equipment for image capture includes analog and digital equipment.

Furthermore, while it is preferred to obtain a series of images in rapid succession of the moving vehicle, that is, moving graphical imagery of the vehicle (i.e., a movie or video of the moving vehicle), the present invention could also be practiced by obtaining one or more images with enough time between the images that they would be considered still images rather than movie or video images. While the term “video” generally refers to moving graphical imagery recorded electronically as opposed “movies” which are recorded on film, as used herein, “video” refers to captured moving graphical imagery regardless of how recorded, transmitted, saved or stored. Additionally, while the present invention may be utilized to obtain a video of a stop arm violation, the method of the present invention includes extraction of one or more still images from the video, for example, a still image of the passing vehicle that clearly shows the license plate.

The “field of view” is the field taken in by a given lens. Different lenses have different fields of view—some can “see” more than others. Wide-angle lenses take in huge areas of a scene, often more than the human eye can at a time. Many image capture devices utilize a viewfinder, either separate or incorporated with the lens, or provide an LCD of the field of view to allow for alignment of the image to be captured. In the present invention, the lens and viewfinder are selected as desired for the particular use or situation.

“Metering” generally refers to the process of calculating the exposure from the existing light conditions. “Spot Metering” generally refers to a method of exposure based on a meter reading of a small circle in the center of the viewfinder. “Matrix Metering” generally refers to an incident light metering system which interprets a series of readings from different points around the frame or view finder (i.e., a matrix of points) to arrive at a suggested exposure. The method of interpretation may involve averaging of readings, ignoring any very high or low readings or the use of more complex computer techniques or algorithms. For example, one may decide to weigh the meter readings on the perimeter of the viewfinder, or those at the top perimeter of the view finder, or left half of the view finder, and so on.

In the development of the present invention, applicant determined that metering which was based on too much of the passing vehicle and surrounding scenery generally would not provide proper metering to adequately capture a readable image of the license plate.

The present invention utilizes a metering algorithm, which will be referred to herein as license plate spot metering, which favors that portion of the viewfinder containing an image of the license plate (the license plate field of view portion) when the automobile is in the viewfinder.

It should be understood that as the vehicle passes thru the viewfinder, the license plate will also appear to pass thru the viewfinder. Generally, the license plate field of view portion is a fixed portion of the viewfinder, so the license plate will also appear to pass thru this license plate field of view portion. It is generally desired to select this license plate field of view portion to such that when the license plate is within that portion, other details of the vehicle may be captured. For example, if the license plate field of view portion is defined at the top of the field of view, when the license plate is within that portion, the portion of the vehicle above the license plate would be above (i.e., out of) the field of view. Alternatively, if the license plate field of view portion is defined at the more toward the bottom of the field of view, when the license plate is within that portion, more or all of the portion of the vehicle above the license plate would be in the field of view.

It is preferred but not necessary that this license plate field of view portion contain only the license plate, as adequate results can be obtained even if images around the periphery of the license plate are included. At some point, however, if too much of the license plate periphery are included, image quality detail will be degraded to a point as to be unusable. How much is too much extra image around the license plate is generally easily determined by trial and error for the particular conditions. It is preferably best to limit the license plate field of view portion to the license plate, more preferably to that portion of the license plate necessary for identification.

Unless the image capture device can be mounted exactly in front of an oncoming vehicle or exactly in back of fleeing vehicle, the vehicle will appear to move across the field of view in a relatively predictable manner.

A vehicle moving toward the image capture device will appear to enter at the top of the field of view and exit at the bottom of the field of view, whereas, a vehicle moving away from the image capture device will appear to enter the bottom of the field of view and exit at the top of the field of view. Also, depending on the direction of the vehicle travel and the mounting direction of the camera on the side of the bus, the vehicle will appear to move from one side to the other of the field of view. In order to obtain not only the vehicle license plate, but also to include an image of vehicle (to further aid identification), care must be taken to select a license plate field of view portion that will allow for such an image.

For example, if the top portion of the field of view were selected as the license plate field of view portion, a front mounted license plate would only be in this top portion of the field of view when the vehicle moved toward the image capture device and thus entered the top of the field of view, or alternatively a rear mounted license plate would only be in this top portion of the field of view when the vehicle moved away from the image capture device and thus exited the top of the field of view. During such a time, while the license plate would be in the top portion of the field of view, the upper part of the vehicle and perhaps even the middle portion of the vehicle would be outside of the field of view.

In contrast, if the middle or bottom portion of the field of view were selected as the license plate field of view portion, a front mounted license plate would be in this middle or bottom portion of the field of view when the vehicle moved toward the image capture device and was close to exiting the middle or bottom of the field of view, or alternatively a rear mounted license plate would be in this middle or bottom portion when the vehicle moved away from the image capture device. During such a time, while the license plate would be in the middle or bottom portion of the field of view, the remainder of the vehicle would be in the visible in the remaining field of view.

Thus, it is preferred to select a license plate field of view portion that is a sufficient distance from the top of the field of view so that the remaining portion of the vehicle will also be in the field of view when the license plate is in the license plate field of view portion.

Where multiple lanes of traffic are being monitored by one camera, the field of view may include multiple license plate field of view portions, one for each lane of traffic.

While the license plate field of view portion has been described above as being a fixed part of the field of view, thru which the license plate will fleetingly pass, the present invention includes embodiments for providing more opportunity for having the license plate within the license plate field of view portion.

One embodiment comprises having the camera track the vehicle a short distance down the road. This embodiment is utilized most easily where the vehicle travel path is somewhat predictable, i.e., adjacent a tool booth, or next to a roadway. A sensing mechanism sensing an approaching vehicle will activate a tracking mechanism which will move the camera thru a predetermined path at a predetermined tracking rate to keep the vehicle in the field of view longer than if the camera were stationary. Optionally, the sensing mechanism will obtain speed of the approaching vehicle, communicate such to the tracking mechanism, with the tracking rate adjusted accordingly. Of course, in many cases, the tracking will not be 100% accurate, but will merely be an approximation, but should provide more data than a fixed camera. Camera tracking may also be provided by a tracking device which will follow/monitor the vehicle and aim the camera at the vehicle.

In another embodiment, the license plate field of view portion is redefined to follow the license plate thru the field of view. A sensing mechanism sensing an approaching vehicle will activate a tracking mechanism which will redefine the license plate field of view portion at various portions of the field of view in a manner designed to track the license plate and keep the license plate in the licensee plate field of view longer than if not redefined. This embodiment too may optionally incorporate vehicle speed to make adjustments. Of course, camera tracking may be combined with redefining the license plate field of view.

In operation, using the license plate field of view portion, camera settings are adjusted based on the meter reading while holding the shutter speed of the image capture device constant. It is preferred to utilized an image capture system that will automatically adjust the remaining camera settings based on meter readings from the license plate field of view portion reading while holding the shutter speed of the image capture device constant.

In making the camera adjustments, it is preferred to give more weight to the meter readings from the license plate field of view portion. Generally, any algorithm which will favor the meter readings from the license plate field of view portion may be utilized.

In the practice of the present invention, image capture device 110, is any image capture device which can obtain an image of passing vehicle 21 that is adequate to make a relatively positive identification of vehicle 21. It is further required that image capture device 110 be capable of operating in a shutter priority mode, that is, a shutter speed is fixed and the aperture is automatically determined by lighting conditions.

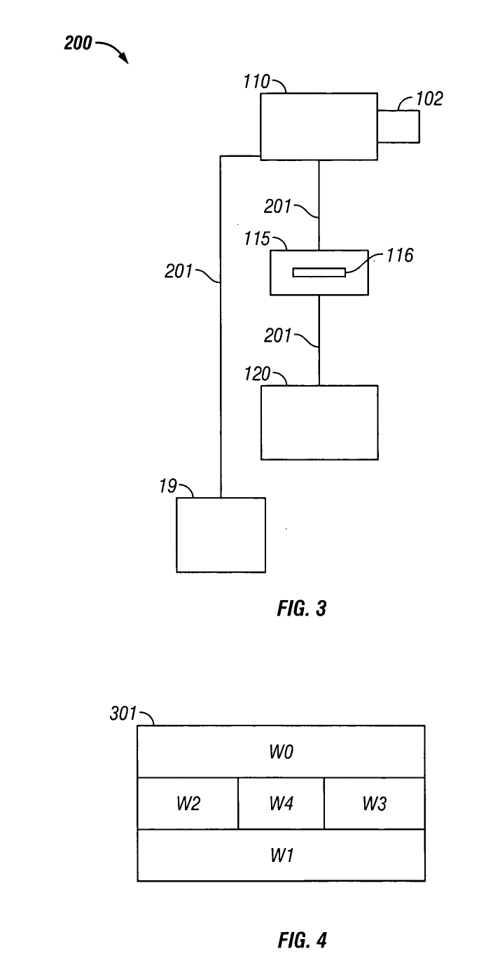

Referring now to FIG. 3 there is shown a schematic representation of image capture system 200 comprising image capture device 110, which can further include image storage device 115, image processor 120 and switch 19. It should be understood that one or more of these system 200 components may be integrated together. Most commonly, one or more of these components may be included in a computer system.

Image storage device 115 may be any digital or analog storage device suitable for storing captured images. Image storage device 115 includes storage media 116, which may be any digital or analog storage media suitable for storing captured images, non-limiting examples of which include film, tape, DVD, hard drive, floppy disc, memory sticks or chips, and the like, any of which may or may not be removable. Image storage device 110 may be integral to or stand alone from image capture device 110.

In order to be more easily accepted in criminal prosecution and civil litigation, any captured image should also be stored with a time/date stamp. Further, many image capture devices comprise a microphone and will also record sound, which will be stored with the image and also useful in court. Multiple cameras can be configured to provide synchronized audio with the video. Use of removable storage media which may be easily labeled, locked and date stamped would also provide forensic value. The present invention may also be enhanced with a GPS system and a radar system for recording location coordinates and vehicle speed along with the date stamp.

Communication connections between any of image capture device 110, storage device 115, processor 120 and switch 19, some of which are shown as connections 201 (although other connections not shown are contemplated, such as between any one to any other), can be by a physical connection or wireless.

It should be understood that image capture apparatus 100 may be in communication with other capture apparatus 100 and/or a remote location by a physical line connection (non-limiting examples of which include phone line, data line, cable or DSL connection, from time to time when the bus stops and connects), or by a wireless connection. This wireless connection may be a real time communication to provide real time images and/or receive instructions/updates, or may be periodic to provide previously recorded images and receive instructions/updates. For example, such updates may be software updates, operational parameter updates, or database updates.

Processor 120, may be integral to or separate from capture device 110 and/or storage device 115, and is generally a computer, processor or microprocessor comprising necessary software and hardware carry out the operation desired of the present invention. For example, to conduct optical character recognition (OCR) and any other data processing on the captured license plate images. OCR technology is readily available, and it is believed that any suitable OCR technology may be utilized. Processor 120 may also comprise a database of license plate numbers for which there are outstanding warnings, bulletins, warrants, alerts and the like. Upon capture and identification of a license plate number matching one in such a database, a message can be communicated to the proper authorities. The system can even be utilized to electronically generate tickets, warrants and the like, which may be printed to be mailed or delivered, or which may be electronically mailed.

It should understood that one or more steps of the method of the present invention is preferably computer implemented.

The product of the present invention includes computer readable media comprising instructions, or a data signal embodied in a carrier wave comprising instructions, said instructions which when carried out on a computer will implement one or more steps of the method of the present invention.

It is preferable that image capture apparatus 100 be operating during the entire travel time of bus 15 to observe traffic not only during the loading/unloading of bus 15, but during the entire travel time. In such a case, image capture apparatus 100 may be equipped with a marking switch operable by the bus driver, allowing for the recording record to be flagged for later review, or for that particular record to be immediately transmitted.

Should storage device 115 be unable to accommodate recording during the entire travel time, then optionally, image capture apparatus 100 may be activated to capture images only during the loading/unloading of bus 15. Switch 19 may be the switch that controls the bus door and stop arm, or may be tied into such a switch. Thus, upon opening of the bus door and engaging stop arm 16, switch 19 would also active image capture apparatus 100 to capture images during the loading/unloading of bus 15. Alternatively, rather than being tied into the bus door and stop arm, switch 19 may be manually operated by the driver as desired.

### EXAMPLE

A number of video cameras from various manufacturers were utilized in a trial and error fashion without adequate success.

Adequate results were obtained after much trial and error with a model EQ500 Day/Night Digital Color Camera from EverFocus Electronics Corp. The inventor believes that the model EQ520 also from EverFocus Electronics Corp. is also useful in the present invention. All versions of the User's Manual and Operating Instructions for the EQ500 and for the EQ520 are herein incorporated by reference. The following is a brief discussion of the proper settings for an EQ500 to obtain suitable images of stop arm violations.

An EQ500 video camera was mounted on a school bus in a manner to capture not only a passing vehicle but also the engaged stop arm. The camera was vibration isolation mounted utilizing closed cell foam between the bus and camera.

The various operating settings for the EQ500 video camera will now be discussed by referring to FIGS. 5-17 which are EQ500 screen displays of the actual operating settings.

Referring now to FIG. 5, there is shown the “switch setup screen.

EXPOSURE is set to “ME” the manual exposure mode to allow the shutter speed to be fixed.

LINELOCK is set to OFF. Linelock is used to make the vertical phase of the camera video signal matched to the phase of the AC power. It is not needed since the camera is being operated on DC battery power.

AWB, or automatic white balance, is a function on the camera to compensate for different colors of light being emitted by different light sources, and is defaulted ON.

DAY/NIGHT, is defaulted ON. The camera is specially designed to have a clear black and white picture under low light environment. The Color and Black/White switching occurs automatically according to the environment, it is a color CCD camera under normal light and Black/White CCD camera under low light. This system works well in ambient light. Generally, if the plate can be seen with the naked eye, the system can capture an image of the plate, although it might have to switch to Black/White mode. While most systems rely upon the reflective or retro-reflective properties of license plates, the present system captures does not rely on a reflection of a strobe or IR light source, but rather captures an ambient light image of the plate. This is crucial, because while license plate numbers are reflective, some elements on a license plate are not reflective. Thus, should the numbers be covered up or obscured, the non-number elements might not reflect the strobe or IR, but could possibly be visible in ambient light.

D/N SWLVL, or day/night switching level, is a parameter, ranging from 00˜99, and is to adjust the day/night switch level. When the value is higher, it will be much more easier to switch Color and Black/White automatically, and vice versa. The default setting is 50. Since it is a daylight test operation, it has been set very low to 01. In the present invention, it is preferred to utilize a camera which will automatically switch to black and white operation in low light.

Referring now to FIG. 6 there is shown an illustration of the EXPOSURE ME screen. The values for AGC have been defaulted to ON and the value for AGC MIN has been defaulted to 1.

AGC, the automatic gain control boosts signal as light decrease and unfortunately boosts noise too. AGC MAX can range from 0-255, and has been changed from its default of 187 to 255. For many conditions, it is preferred not to use AGC.

Referring now to FIG. 7 there is shown an illustration of the VIDEO SETUP screen. All values have been defaulted except for BRIGHT which has been changed from its default of 120 to 125. BRIGHT can range from 0-255 and it to adjust brightness of the video. The higher the value the brighter the video.

Referring now to FIG. 8 there is shown an illustration of the VIDEO SETUP2 screen. All values have been defaulted.

Referring now to FIG. 4, there is shown a layout of optical detect window 301 comprising 5 separate windows W0, W1, W2, W3 and W5, which the EQ500 video camera utilizes in an Optical Detect (OPD) method to detect luminous for various camera settings. The EQ500 video camera provides for adjustment of window W4 position and size. Adjustment of window W4 position and size will adjust position and size of the remaining windows W0, W1, W2 and W3.

Referring now to FIGS. 9 and 10 there are shown are illustrations of the OPD SETUP screen. These screens control the size and position of each of the five windows W0-W4. Using them, W4 has a size of 0, and positioned such as to reduce the vertical size of W0, and increase the vertical size of W1 (with windows W0-W3 shown below in FIGS. 18-20).

Referring now to FIGS. 11-14 there are shown illustrations of the OPD WEIGHT SETUP screen. Relative weights for each of the five windows W0-W4 can be set from 0-15. These relative weights are utilized in the exposure, back light compensation and automatic white balance algorithms. The contribution of the window is directly proportional to its value. So, a window having a value of 15 is weighted 5 times a window having a value of 3, and 15 times a window having a value of 1. The OPD weights for windows W0, W1, W2 and W3, are 1, 15, 3, and 3, respectively.

Referring now to FIG. 15 there is shown an illustration of the LINELOCK SETUP screen.

Referring now to FIG. 16 there is shown an illustration of the AWB SETUP screen. Default values were accepted for SPEED and WINDOW SEL. SPEED, has a default of 1, and is a parameter ranging from 1-14, to adjust the speed of the automatic white balance. Higher values mean slower speed, and lower values mean higher speed. WINDOW SEL determines which windows to use in the AWB algorithm, with the default being all windows. The RANGE is the tracing range of the AWB. FRM Less is for a color temperature ranging from 2000K to 18,000K.

Referring now to FIG. 17, there is shown a return to the SWITCH SETUP screen, showing a complete cycle through the setup screens.

Referring now to FIGS. 18-20, there is show vehicle moving in direction of travel 3 in various positions of travel through camera 110 view zone 23, with OPD window 301 superimposed thereon.

Referring now to FIG. 18, there is shown the state of OPD window 301 just prior to entry into the window by vehicle 21.

Referring now to FIG. 19, there is shown the state of OPD window 301 just upon entry of the front of vehicle 21 into OPD window 301, specifically window W1. Camera 110 will start to compensate and correct exposure and lighting settings based on the weighting and positions of the windows W0-W3.

Referring now to FIG. 20, there is shown the state of OPD window 301 upon full entry of vehicle 21 into OPD window 301. Specifically, license plate 34 is in window W1. Camera 110 will compensate and correct exposure and lighting settings based on the weighting and positions of the windows W0-W3.

The system as described in this example was mounted on a school bus. In a test with an empty school bus, the stop arm was extended and the law enforcement vehicle moved past the bus at 65 mph. The resultant image showed the stop arm, date stamp, license plate (clearly), color of the vehicle, and enough details of the vehicle to allow for a reasonable assessment of the make/model of the vehicle. In another test run at a shutter speed of 1/10000, the bus moving down the road at about 45 mph was approached by a vehicle moving at about 75 mph, for a differential speed of about 120 mph. The resultant image showed the stop arm, date stamp, license plate (clearly), color of the vehicle, and enough details of the vehicle to allow for a reasonable assessment of the make/model of the vehicle.

While the present invention has been described mainly by reference to school bus stop arm violations, it should be understood that it has a wide range of applicability.

For example, rather than being configured to read a license plate, the present invention could be configured to read an inspection sticker, pass or other indicia displayed on the vehicle.

In addition to being mounted on the side of a school bus, image capture system 100 of the present invention could be mounted adjacent a highway or on a roving vehicle for the sole purpose of capturing licensing plates and checking them against a database in the search for criminals, suspects or stolen vehicles. Coupled with a radar system, the present invention could issue and generate a speeding ticket to be mailed, emailed or otherwise delivered to the address of record corresponding to the license plate number.

The present invention may be mounted on any type of roving vehicle, manned or unmanned, for land, sea or air. As non-limiting examples, in addition to being mounted on a roving motorized vehicles (i.e., cars, trucks, motorcycles, unmanned vehicles), the present system could be mounted on any roving object, such as aircraft including planes, jets, helicopters, unmanned drones, balloons, and such as water craft including boats, ships, wave runners, ski boats, and sailboats.

When utilized with a roving vehicle, inspection/surveillance could be the sole or secondary purpose of the roving. For example, designated patrol vehicles could drive random or predetermined paths in the search for wanted vehicles/persons or to witness violations. Or, cameras could be mounted on vehicles which are otherwise traveling about, for example, trains, trams, buses, delivery vehicles, taxis, service vehicles, or volunteer vehicles. Some of these vehicles would be traveling predicted paths (i.e., buses), others would be traveling random paths. Monitoring of dangerous areas, such as railroad crossings, and areas immediately adjacent train tracks can be easily accomplished by mounting the present invention on a traveling train or inspection vehicle traveling the tracks.

The present invention may also be mounted on a vehicle for the purpose of personal security. Upon the encountering of a dangerous situation, the system may be equipped with a panic/activation button which will not only alert authorities, but will also provide pictures or video and optionally audio, either previously recorded, or real time images, and also provide location information from perhaps a GPS system. Any suitable image capture system may be utilized in this personal safety system, although it is preferred if license plate information is to be captured of a rapidly passing vehicle that the image capture system as described above be utilized. Of course, the system could be continuously operating.

The present invention also finds utility with time and distance speed monitoring, in which a vehicle image is captured and identified on a certain road at a first point, and then captured and identified on that same road at a second point. Image capture systems positioned at the first and second points, and in communication with each other, could then determine the elapse time and calculate speed, and subsequently issue a ticket if warranted.

The present invention also finds utility in any application in which it is necessary or useful to identify a passing vehicle, such as assess to controlled parking areas, access control to a secured area, tolling, border control, stolen cars, enforcement, traffic control, marketing tool, parking charge calculation.

Generically, the present invention finds utility in any application where it is necessary or useful to obtain an identifiable image of a passing object (whether animate or inanimate). As used herein, “passing object” merely means there is relative motion between the object and the image capture system, that is, the camera could be fixed and the object moving past, or the object could be fixed with the camera moving past, or both could be moving but with apparent motion of one relative to the other.

The system finds utility, preferably where the relative speed between the passing object and the image capture system is greater than 0.1 mph, preferably greater than 1 mph, more preferably greater than 10 mph, even more preferably greater than 20 mph, still more preferably greater than 30 mph, yet more preferably greater than 40 mph, even still more preferably greater than 60 mph, even yet more preferably greater than 80 mph, still even more preferably greater than 100 mph, and still yet more preferably greater than 150 mph. The upper limit on a moving object that can be captured in the desire detail will depend upon the operational speed of the camera. It is believed that as camera adjustment response times become quicker, faster moving object can be captured at the desired level of detail.

As another non-limiting example, the present invention may also find utility on a rapidly moving assembly line where it is important to monitor a manufacturing process, especially assembled or partially assembled objects as they speed along the assembly line.

The present invention also finds utility in high speed inspections. For example, for monitoring roadways, including highways, streets, roads, toll roads, by ways, pavement and the like, or for monitoring rail tracks, including train tracks, monorail tracks, subway tracks and the like.

In such a highway monitoring application, the image capture system is mounted on an inspection vehicle and pointed toward the road. The inspection vehicle then travels the roadway (preferably at a relatively constant speed) to be monitored searching for potholes and other roadway imperfections. Preferably, the camera shutter speed is locked on a speed based on the speed of the inspection vehicle and road surface so that the resultant roadway will appear as a continuous blur. The appearance of a pothole provides a stark contract that can easily be identified using any suitable algorithms. Coupled with a positioning system, such as a GPS system, or with a system that utilizes starting position, time and speed, the position of the pothole or anomaly can be determined.

In a test of such a highway inspection system, the inventor found that using the model EQ500, locking the shutter speed at 1/10000 and operating the vehicle at 60 mph, the roadway appeared as a blur and the potholes provided a start contrast to the continuous blur. A metering window was created that was narrow and elongated and oriented such as to allow the roadway to remain in the window for as long as possible. Thus, the roadway will appear to enter one narrow end of the window and exit the other narrow end of the window, rather than appear to travel across the elongated ends.

As another non-limiting example, similar to the highway monitoring system, a track monitoring system can be mounted on an operating train, or on an inspection vehicle that will travel the tracks, to monitor the tracks and/or areas adjacent the tracks.

As another non-limiting example, mounted on a patrol vehicle, license plates of parked cars can be rapidly obtained by driving the patrol vehicle past parked cars.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth herein but rather that the claims be construed as encompassing all the features of patentable novelty which reside in the present invention, including all features which would be treated as equivalents thereof by those skilled in the art to which this invention pertains. Additionally, it should be understood that not all of the inventions described herein have been incorporated into the claims as originally filed, and that claims may be later added directed to other inventions described herein.

All patents and publications cited herein are hereby incorporated by reference for all that they teach and suggest.

What is claimed is:

1. A method of obtaining an image with an image capture device of a license plate mounted on a vehicle, wherein the image capture device has a field of view, the method comprising:
determining, while the license plate is in a license plate portion of the field of view, an exposure for the device based on a meter reading that places greater weight the license plate portion of the field, than on any portions of the field of view in the license plate is not positioned, wherein the license plate portion is only a portion of the field of view;
adjusting settings for the image capture device based on the meter reading while holding device shutter speed fixed; and
capturing an image of the field of view.

2. An image capture system comprising:
a vehicle; and
an image capture device mounted on the vehicle, operating at a fixed shutter speed, wherein the image capture device comprises a field of view comprising a license plate portion of the field of view that is only a portion of the field of view, wherein the image capture device generates a meter reading that places greater weight on the license plate portion of the field, than on any portions of the field of view, and wherein the image capture device operates to capture an image based on that meter reading.

3. The system of claim 2, wherein the vehicle is a school bus.

4. The system of claim 3, wherein the bus comprises a stop arm, and the image capture device is positioned to include the stop arm in the field of view.

5. A method of obtaining an image with an image capture device of a license plate mounted on a moving vehicle, wherein the image capture device is mounted on a second vehicle and has a field of view, the method comprising:
determining, while license plate is in a license plate portion of the field of view, an exposure for the device based on a meter reading that places greater weight the license plate portion of the field, than on any portions of the field of view in which the license plate is not positioned, wherein the license plate portion is only a portion of the field of view;
adjusting settings for the image capture device based on the meter reading while holding device shutter speed fixed; and
capturing an image of the field of view.

6. A method of obtaining an image with an image capture device of a license plate mounted on a moving vehicle passing a school bus with a stop arm, wherein the image capture device has a field of view, wherein the image capture device is mounted on the school bus, the method comprising:
determining, while license plate is in a license plate portion of the field of view, an exposure for the device based on a meter reading that places greater weight the license plate portion of the field, than on any portions of the field of view in which the license plate is not positioned, wherein the license plate portion is only a portion of the field of view;
adjusting settings for the image capture device based on the meter reading while holding device shutter speed fixed;
capturing an image of the field of view which includes the vehicle and the stop arm.
